(19) United States
(12) Patent Application Publication
(10) Pub. No.: US 2002/0138732 A1
(43) Pub. Date: Sep. 26, 2002

(54) Methods, systems and computer program products for providing digital signatures in a network environment

(76) Inventor: David R. Irvin, Raleigh, NC (US)

Correspondence Address: MYERS BIGEL SIBLEY & SAJOVEC, PO BOX 37428, RALEIGH, NC, 27627, US

(21) Appl. No.: 09/816,006

(22) Filed: Mar. 23, 2001

(51) Int. Cl. H04L 9/00

(52) U.S. Cl. 713/176; 713/180

(57) ABSTRACT

Methods, systems and computer program products are discussed for authenticating a message. A first random number may be generated at a first station according to a predetermined random number generation algorithm and the first random number may be used to construct a first security field. The first security field may be encrypted to create a first digital signature and the first digital signature may be appended to the message to create a packet. The packet, including the message and the first digital signature, may be transmitted from the first station and received at a second station. A second random number may be generated at the second station according to the predetermined random number generation algorithm. A second security field may be constructed at the second station that includes the second random number. Finally, the second security field, including the second random number, may be compared to the first digital signature.

### BACKGROUND OF THE INVENTION

The present invention relates to data communications and, more particularly, to authenticating messages.

Command authentication and communication network access are respectively discussed in U.S. Pat. No. 5,293,576 to Mihm, Jr. et al. (“Mihm”) and U.S. Pat. No. 5,440,633 to Augustine et al. (“Augustine”). Mihm, for example, discusses a slave station, such as an orbiting satellite, and a master station, such as a ground control station, that each have their own lists of random pads. The master and slave station lists are identical. When the master station sends a critical command to the slave station, a selected one of the pads is combined with the command and transmitted to the slave station as a data communication message. Each pad is only used once. The slave station evaluates the received pad value using its version of the same selected pad. If the evaluation detects correspondence, then the command is authenticated and the slave station acts on the command.

Augustine discusses a network management frame that contains a clear text (unencrypted) management command field and a security field. The management frame is sent to a data communications network by an authorized managing entity (manager). The management frame is addressed to a managing agent (agent). The security field includes two sub fields. The first sub field is a clear text time stamp. The second sub field includes this same time stamp value concatenated with a checksum that is calculated by the manager for the specific clear text management command contained within the management frame. The concatenated value is then encrypted under a secret cryptographic key that is shared by the manager and the agent. The agent receives the management frame, calculates a checksum of the clear text management command, and appends this checksum to the clear text time stamp as contained in the received management frame. This value is then encrypted using the shared cryptographic code. If the result matches the second sub field of the received management command, integrity of the received management command is assured.

### SUMMARY OF THE INVENTION

Methods, systems and computer program products according to embodiments of the present invention can provide digital signatures in a network environment. Embodiments of the present invention may transmit a message, generate a random number according to a predetermined random number generation algorithm and construct a first security field including the random number. The first security field may be encrypted to create a first digital signature and first digital signature may be appended to the message to create a packet. The packet, including the first digital signature and the message, may be transmitted. Further embodiments of the present invention may receive the packet including a message and a first digital signature and generate a second random number according to the predetermined random number generation algorithm. The second random number may be used in constructing a second security field. The second security field may be compared to the first digital signature.

### BRIEF DESCRIPTION OF THE DRAWINGS

FIG. 1 is a block diagram of a network environment according to embodiments of the present invention.

FIGS. 2A and 2B are block diagrams of stations according to embodiments of the present invention.

FIG. 3 is a block diagram of a packet according to embodiments of the present invention.

FIG. 4 is a flowchart illustrating operations for transmitting a packet according to embodiments of the present invention.

FIG. 5 is a flowchart illustrating operations for receiving a packet according to embodiments of the present invention.

FIG. 6 is a flowchart illustrating operations for transmitting a packet according to further embodiments of the present invention.

FIG. 7 is a flow diagram illustrating operations for receiving a packet to further embodiments of the present invention.

### DETAILED DESCRIPTION OF THE INVENTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. It will also be understood that when an element is referred to as being “connected” or “coupled” to another element, it can be directly connected or coupled to the another element or intervening elements may be present. In contrast, when an element is referred to as being “directly connected” or “directly coupled” to another element, there are no intervening elements present.

As will be appreciated by one of skill in the art, the present invention may be embodied as methods, systems, or computer program products. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code means embodied in the medium. Any suitable computer readable medium may be utilized including hard disks, CD-ROMs, optical storage devices, a transmission media, such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function or act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions or acts specified in the flowchart and/or block diagram block or blocks.

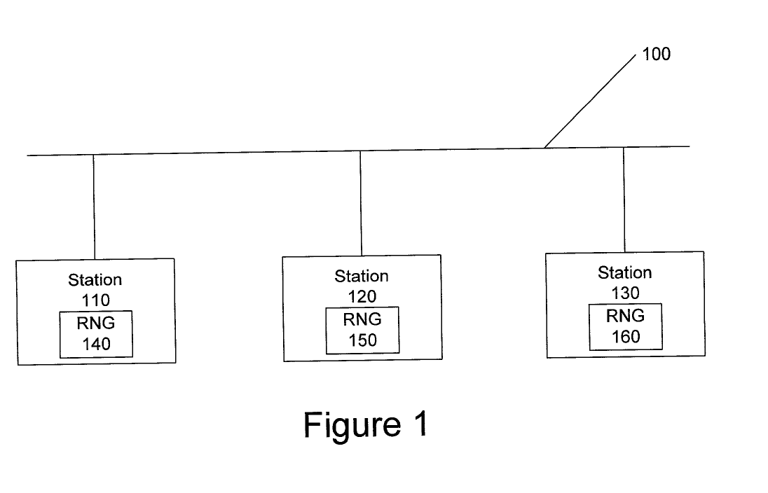

FIG. 1 is a block diagram which illustrates a network 100 that includes stations 110, 120, and 130. The network 100 may be a multiple-access communication network or the like. For the illustrated embodiments, each of the stations 110, 120, and 130 is connected to the network 100. Thus, the network 100 may provide a connection between the stations 110, 120, and 130. Although only three stations 110, 120, and 130 are shown in FIG. 1, it will be understood by those having skill in the art that this number is used for exemplary purposes only and that many more or fewer stations may be employed. Furthermore, stations 110, 120, and 130 may all be peer stations. Alternatively, one or more of stations 110, 120, and 130 may be a master station(s) with the remaining stations being slave stations responsive to the master station(s). The network, for example, may be one of a wired, wireless, optical, or radio frequency network or combinations thereof used to communicate one of data, voice, and video, or image communications or combinations thereof.

As shown in FIG. 1, each of stations 110, 120, and 130 includes a random number generator (RNG) according to embodiments of the present invention. The random number generators 140, 150, and 160 of the present invention typically generate random numbers according to a common predetermined random number generation algorithm at each of stations 110, 120 and 130. Accordingly, the same random number may be available to all stations on the network 100 and therefore a verifiable digital signature may be created by encrypting this random number along with other data as appropriate. Including the random number in the digital signature also provides each message with a different signature, thus thwarting the capability of a vandal to capture and resend the message.

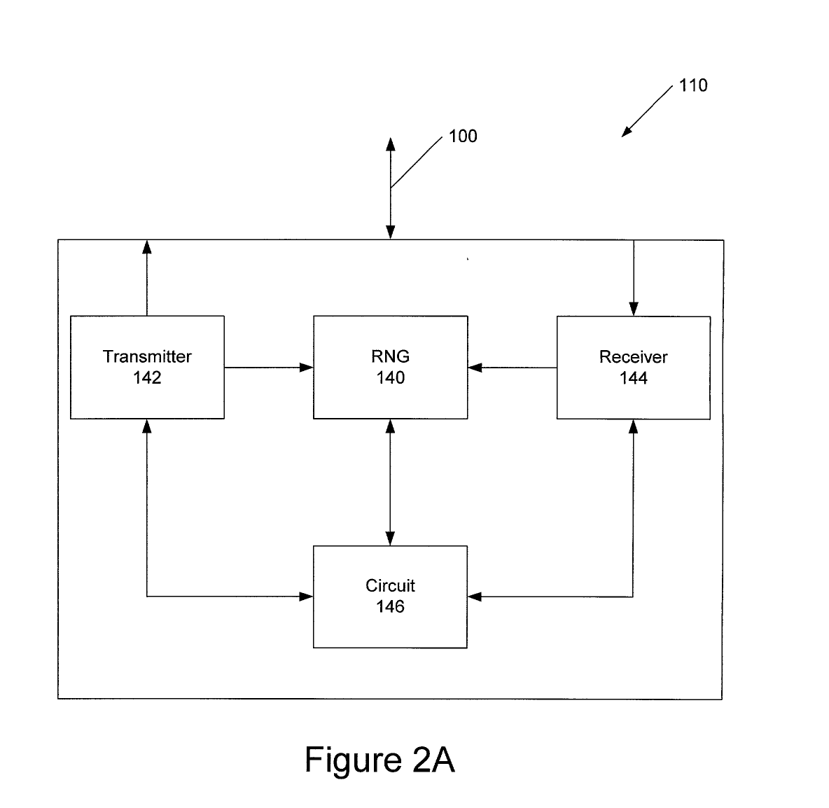

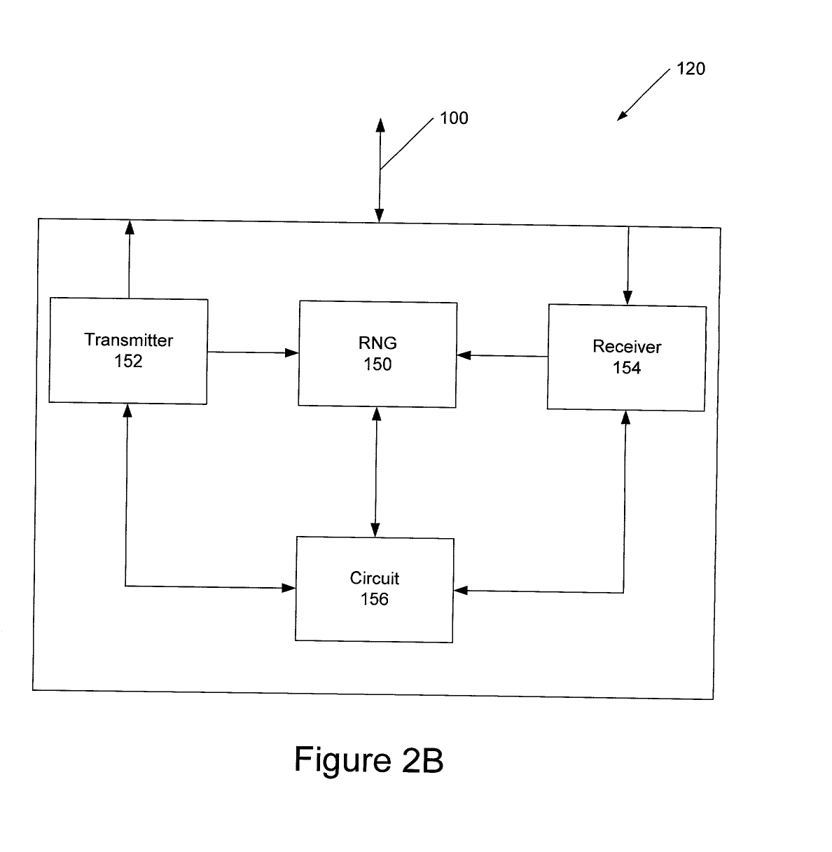

Now referring to FIGS. 2A and 2B, stations 110 and 120 of FIG. 1 are illustrated according to embodiments of the present invention. Station 110 and station 120 may include transmitters 142 and 152, respectively, that are operative to transmit packets over the network 100 to other stations on the network 100. Stations 110 and 120 may also include receivers 144 and 154 that are operative to receive packets over the network 100 from other stations on the network. Accordingly, a station according to embodiments of the present invention may transmit and receive over the network, transmit over the network but not receive, or receive from the network and not transmit.

Stations 110 and 120 may further include random number generators (RNG) 140 and 150, respectively. Each station on the network 100 may be equipped with a similar random number generator as shown in FIG. 1. The random number generators may be synchronized so that the random numbers generated are the same for every transmit/receive pair. For example, if the first random number generated at a transmitting station is 12, the second random number generated at a receiving station will also be 12. In other words, a common predetermined random number generation algorithm operates at both the first and second stations using a common seed to produce the same random number at each station. The seed may be derived from an encryption key or keys, or may be distributed separately by a means used to distribute the encryption key or keys. The random number generators may be advanced with the transmission and/or reception of each packet. Moreover, the random number generators of all network stations may be periodically synchronized to insure that a common random number is generated at each station during each transmit/receive pair. Thus, each station may have access to the same random number regardless of whether the station is transmitting or receiving the packet.

As shown in FIGS. 2A and 2B, stations 110 and 120 may also include circuits 146 and 156, respectively, operative to execute programs that may construct a packet at a first station (transmitting station) and authenticate the packet at a second station (receiving station). Stations 110 and 120 may also include other functional modules not illustrated in FIGS. 2A and 2B but which will be understood by those of skill in the art related to communications in a network environment.

The present invention will now be further described by way of example with reference to the block diagrams of FIGS. 2A and 2B. Assuming station 110 is transmitting a message, random number generator 140 may generate a first random number according to the predetermined random number generation algorithm discussed above. Circuit 146 may construct a first security field that includes the first random number generated by random number generator 140. Circuit 146 may also compute a Cyclic Redundancy Check (CRC) for the message. The processes for computing a CRC for the message are known to those of skill in the art and will not be discussed further herein. The Circuit 146 may include the CRC in the first security field and may also append the CRC to the message.

Circuit 146 may encrypt the first security field to create a first digital signature and append the first digital signature to the message to create the packet. Therefore, the packet may include the message, the CRC and the first digital signature. Alternatively, the packet may include only the message and the first digital signature, or the packet may include the message, the CRC, the first digital signature and any additional fields that may be desirable. At this point, assuming that station 120 is to receive the packet including the message, transmitter 142 may transmit the packet over the network 100 to station 120.

The packet, including the first digital signature and the message, may be received at receiver 154 of the receiving station 120. The random number generator 150 may generate a second random number according to the same predetermined random number generation algorithm used by the transmitting station 110. As discussed above, the random numbers generated at the transmitting station 110 and the receiving station 120 are typically the same random number (i.e. a common random number is generated at each station during each transmit/receive pair). It will be understood that the random number generators may be advanced with the transmission and/or reception of each packet as long as the same random number is generated for each transmit/receiver pair.

Circuit 156 may construct a second security field that includes the second random number. If a CRC for the message was included in the first security field, circuit 156 may compute a second CRC for the message and include the second CRC in the second security field. Alternatively, circuit 156 may include the CRC computed at station 110 in the second security field. Circuit 156 may compare the second security field to the first digital signature. Circuit 156 may compare the second security field with the first digital signature, for example, by encrypting the second security field to generate a second digital signature and comparing the first and second digital signatures. Alternatively, circuit 156 may compare the second security field with the first digital signature by unencrypting the first digital signature and comparing the unencrypted first digital signature with the second security field.

Circuit 156 may determine the validity of the message based on the comparison of the second security field and the first digital signature. For example, if the first and second digital signatures are the same, the message may be valid. Circuit 156 may reject the packet if the message is determined to be invalid (i.e. the first and second digital signatures are not the same). Although the previous example assumes that station 110 is a transmitting station and that station 120 is a receiving station, it will be understood that this is for exemplary purposes only and that these stations are not limited to these functions. It will be understood that stations according to embodiments of the present invention on network 100 may be combination transmit and receive stations, receive only stations and/or transmit only stations.

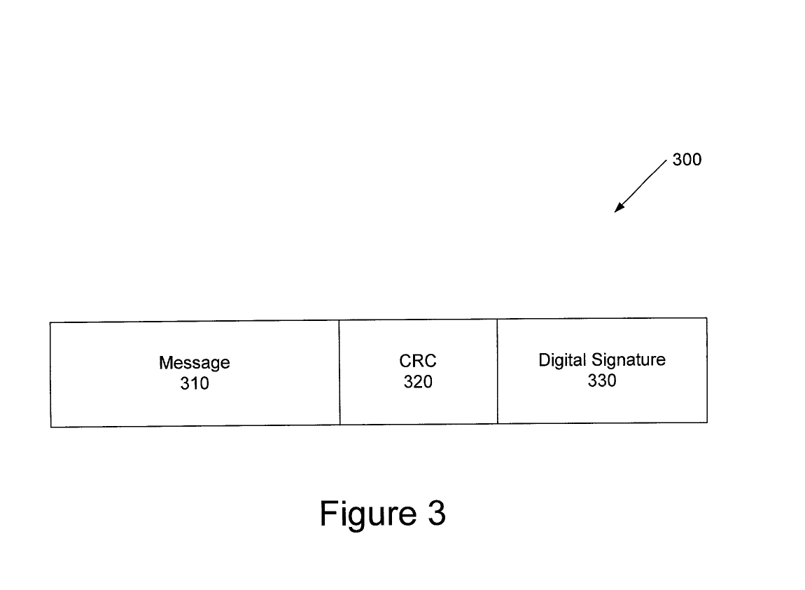

It will be appreciated that the transmitters, receivers, random number generators and circuits of stations 110 and 120 may be implemented using a variety of hardware and software. For example, operations of the transmitter and/or receiver may be implemented using special-purpose hardware, such as an application specific integrated circuit (ASIC) and programmable logic devices such as gate arrays, and/or software or firmware running on a computing device such as a microprocessor, microcontroller or digital signal processor (DSP). It will also be appreciated that, although functions of the transmitter, receiver and the other circuits shown in FIGS. 2A and 2B may be integrated in a single device, such as a single ASIC microprocessor, they may also be distributed among several devices. Aspects of these circuits may also be combined in one or more devices, such as an ASIC, DSP, microprocessor or microcontroller. These various implementations using hardware, software, or a combination of hardware and software will generally be referred to herein as “circuits.” The present invention will now be further described with reference to the block diagram of FIG. 3 which illustrates a packet 300 according to embodiments of the present invention. As illustrated in FIG. 3, the packet may include a message 310, a Cyclic Redundancy Check (CRC) 320, and a digital signature 330. The CRC is computed for the message 310. The CRC may be provided in the packet unencrypted to allow network stations that lack de-encryption means to verify the message using the CRC. Steps for computing a CRC for a message are known to those of skill in the art and will not be discussed further herein. According to alternate embodiments of the present invention, the CRC 320 may not be required.

Although the packet 300 is shown as containing three components 310, 320, and 330 in FIG. 3, it will be understood by those having skill in the art that this arrangement is for exemplary purposes only and that many other components may be included in the packet. The packet may be assembled at a first station (transmitting station) and transmitted to a second station (receiving station) as discussed in detail above.

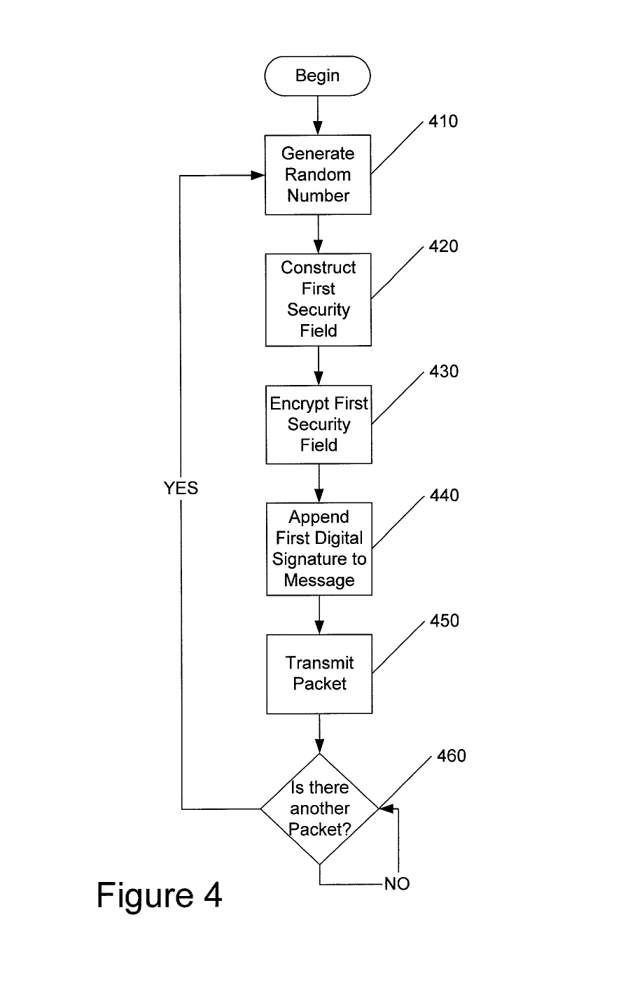

Operations according to embodiments of the present invention for transmitting a message will now be further described with reference to the flow chart illustration of FIG. 4. Operations begin with the generation of a first random number according to a predetermined random number generation algorithm at a first station (transmitting station) (block 410). A first security field may be constructed (block 420) and may include the first random number generated in block 410. The first security field may be encrypted to create a first digital signature (block 430). Steps for encrypting data are discussed in U.S. Pat. No. 5,293,576 to Mihm, Jr. et al. and U.S. Pat. No. 5,440,633 to Augustine et al., the disclosures of which are incorporated herein by reference. The first digital signature may be appended to the message to create a packet (block 440). The packet may be transmitted to one or more receiving stations in the network (block 450). It may be determined if there is another packet to be transmitted (block 460). If it is determined that there is another packet to be transmitted (block 460), operations may return to block 410 and repeat until it is determined that there are no other packets to be transmitted. If it is determined that there is not another packet to be transmitted (block 410) operations may remain at block 460 until another packet exists.

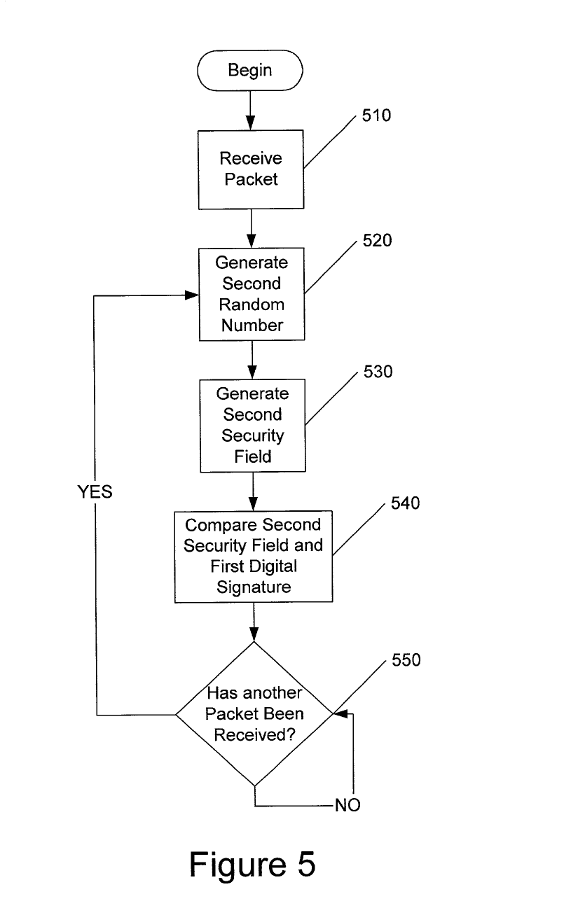

Operations according to embodiments of the present invention for receiving a packet at a second station (receiving station) from a transmitting station on the network, will now be further described with reference to the flow chart illustration of FIG. 5. While operations are discussed with respect to a single receiving station, multiple stations on the network may receive the packet. Operations begin at block 510 with the receipt of the packet generated at the transmitting station as discussed above with respect to FIG. 4 at a receiving station. The packet may include a message, a CRC and a first digital signature. Alternatively, the packet may not include the CRC, or may include any other desirable fields. A second random number may be generated (block 520) according to the same predetermined random number generation algorithm used to generate the first random number discussed above. The first and second random number generators may be synchronized so that the first and second random numbers are the same for every transmit/receive pair. For example, if the first random number generated at the first station is 12, the second random number generated at the second station will also be 12. In other words, the same predetermined random number generation algorithm operates at both the first and second stations using a common seed to produce the same random number at each station. Moreover, the random number generators of all network stations may be periodically synchronized to insure that a common random number is generated at each station during each transmit/receive pair. It will be understood that the random number generators may be advanced with the transmission and/or reception of each packet as long as the same random number is generated for each transmit/receiver pair.

A second security field may be generated that includes the second random number (block 530). The second security field including the second random number may be compared to the first digital signature (block 540). The second security field can be compared with the first digital signature, for example, by encrypting the second security field to generate a second digital signature and comparing the first and second digital signatures. Alternatively, the second security field may be compared with the first digital signature by unencrypting the first digital signature and comparing the unencrypted first digital signature with the second security field.

It is determined if another packet has been received (block 550). If it is determined that another packet has been received (block 550), operations return to block 520 and repeat until it is determined that no other packets have been received. If it is determined that another packet has not been received (block 550), operations remain at block 550 until another packet is received.

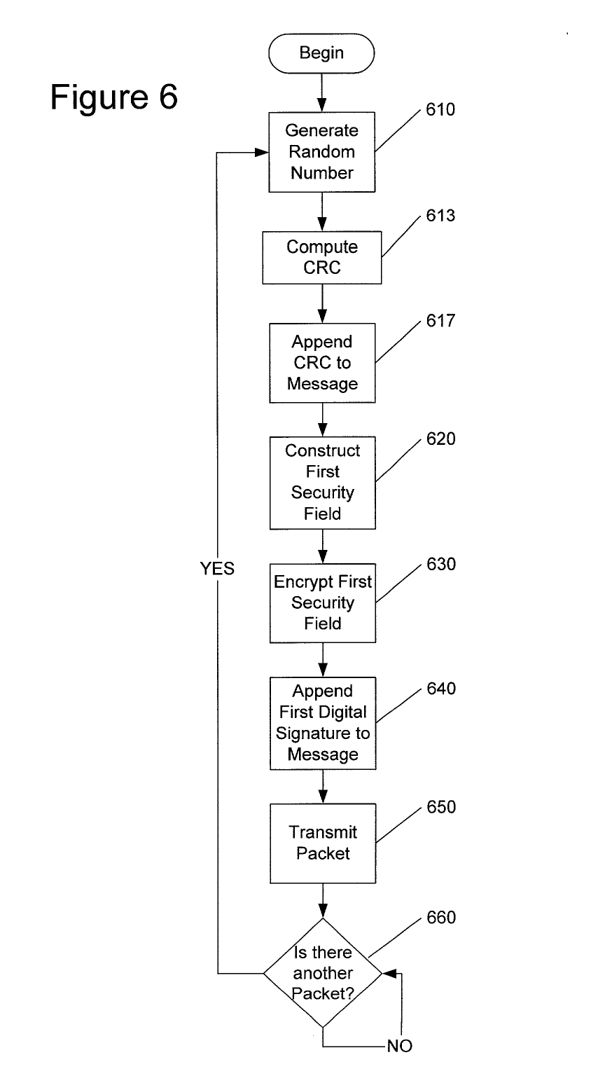

Operations according to other embodiments of the present invention for transmitting a packet to one or more stations on a network, will now be described with reference to the flow chart illustration of FIG. 6. Operations begin at block 610 with the generation of a first random number according to a predetermined random number generation algorithm at a first station (transmitting station). A Cyclic Redundancy Check (CRC) may be computed (block 613) for the message and may be appended to the message (block 617) as shown in FIG. 3. A first security field may be constructed (block 620) at the first station and may include the random number generated in block 610. The first security field may also include the CRC computed in block 613. The first security field may be encrypted to create a first digital signature (block 630). The first digital signature may be appended to the message to create a packet (block 640). The packet may include the message, the CRC, and the first security field. The packet may be transmitted to one or more receiving stations in the network (block 650). It may be determined if there is another packet to be transmitted (block 660). If it is determined that there is another packet to be transmitted (block 660), operations may return to block 610 and repeat until it is determined that there is no other packets to be transmitted. If it is determined that there are no other packet to be transmitted (block 610) operations may remain at block 660 until another packet exists.

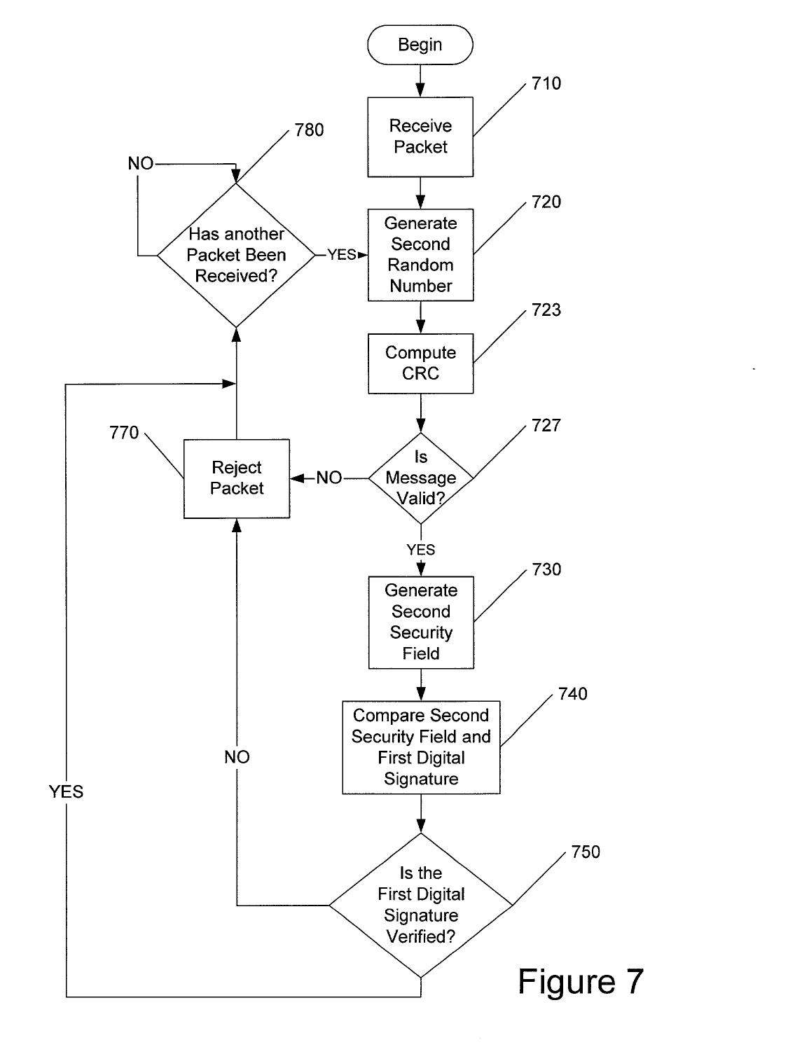

Operations according to embodiments of the present invention for receiving packets at a second station (receiving station) from a transmitting station on the network, will now be described with reference to the flow chart illustration of FIG. 7. While operations are discussed with respect to a single receiving station, multiple stations on the network may receive the packet. Operations begin with the receipt of the packet generated as discussed above with respect to FIG. 6 at a second station (block 710). As discussed above, the packet may include a message, a CRC and a first digital signature. A second random number may be generated (block 720) according to the same predetermined random number generation algorithm used to generate the first random number discussed above. It will be understood that the random number generators may be advanced with the transmission and/or reception of each packet as long as the same random number is generated for each transmit/receiver pair.

A Cyclic Redundancy Check (CRC) may be computed for the message (block 723). The CRC may be used to verify that the message portion of the block is valid. It will be understood by those having skill in the art that a CRC does not have to be generated at the second station and that the computation of the CRC shown in FIG. 7 is for exemplary purposes only and that the invention will not be considered as limited to this arrangement. For example, the CRC computed at the transmitting station may be retrieved from the packet and used to check the validity of the message.

It is determined if the message is valid using the CRC (block 727). If the message is determined to be invalid (block 727), the packet may be rejected by the second station (block 770). It may be determined if another packet has been received (block 780). If it is determined that another packet has been received, operations may return to block 720 and repeat until it is determined that another packet has not been received. If it is determined that another packet has not been received (block 780), operations may remain at block 780 until another packet is received.

If the message is determined to be valid using the CRC (block 727), a second security field may be generated at the second station that includes the second random number (block 730) and the CRC. The second security field including the second random number may be compared to the first digital signature (block 740). The second security field may be compared with the first digital signature, for example, by encrypting the second security field to generate a second digital signature and comparing the first and second digital signatures. Alternatively, the second security field may be compared with the first digital signature by unencrypting the first digital signature and comparing the unencrypted first digital signature with the second security field.

It is determined if the first digital signature is verified (block 750). For example, the first digital signature may be verified by determining if the first and second digital signatures are the same, or if the second security field and the unencrypted first digital signature are the same. If the first digital signature is verified (block 750), it may be determined if another packet has been received (block 780). If it is determined that another packet has been received, operations may return to block 720 and repeat until it is determined that another packet has not been received. If it is determined that another packet has not been received (block 780), operations may remain at block 780 until another packet is received.

If the first digital signature is not verified (i.e. the first and second digital signatures are not the same or the second security field and the unencrypted first digital signature are not the same), the packet may be rejected by the second station (block 770). It may be determined if another packet has been received (block 780). If it is determined that another packet has been received, operations may return to block 720 and repeat until it is determined that another packet has not been received. If it is determined that another packet has not been received (block 780), operations may remain at block 780 until another packet is received.

Methods, systems and computer program products for providing a digital signature in a network environment have been described in detail above. A digital signature according to embodiments of the present invention may be provided by including a random number generator (RNG) in each station of a network. The random number generators of the present invention typically generate random numbers according to a common predetermined random number generation algorithm at each station. Accordingly, the same random number may be available to all stations on the network and therefore a verifiable digital signature may be created by encrypting this random number along with other data as appropriate. Aspects of the present invention may provide advantages over the prior art. By generating the random number and security field at each transmitting and receiving station using random number generators operating according to a common random number generation algorithm at each station, the prior transmission of pad lists as discussed in U.S. Pat. No. 5,293,576 is not required. Accordingly, a risk of unauthorized interception of pad lists can be reduced, and utilization of network bandwidth can be reduced. Nevertheless, including the random number of the present invention in the digital signature provides each message with a different signature each time it appears, thus reducing the ability of a vandal to capture and resend the message.

Operations of the present invention have been described with respect to the block diagram illustrations of FIGS. 1 through 3 and the flowchart illustrations of FIGS. 4 through 7. It will be understood that each block of the flowchart illustrations and the block diagram illustrations of FIGS. 1 through 7, and combinations of blocks in the flowchart illustrations and the block diagram illustrations, can be implemented by computer program instructions. These program instructions may be provided to a processor to produce a machine, such that the instructions which execute on the processor create means for implementing the functions specified in the flowchart and block diagram block or blocks. The computer program instructions may be executed by a processor to cause a series of operational steps to be performed by the processor to produce a computer implemented process such that the instructions which execute on the processor provide steps for implementing the functions specified in the flowchart and block diagram block or blocks.

Accordingly, blocks of the flowchart illustrations and the block diagrams support combinations of means for performing the specified functions, combinations of steps for performing the specified functions and program instruction means for performing the specified functions. It will also be understood that each block of the flowchart illustrations and block diagrams, and combinations of blocks in the flowchart illustrations and block diagrams, can be implemented by special purpose hardware-based systems which perform the specified functions or steps, or combinations of special purpose hardware and computer instructions. For example, the circuits 146 and 156 may be implemented as code executing on a processor, as integrated circuit devices, such as signal processors or custom chips, or as a combination of the above.

The flowcharts and block diagrams of FIGS. 1 through 7 illustrate the architecture, functionality, and operation of possible implementations of systems, methods and computer program products for authenticating messages received from stations in a network environment according to various embodiments of the present invention. In this regard, each block in the flow charts or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved.

In the drawings and specification, there have been disclosed typical illustrative embodiments of the invention and, although specific terms are employed, they are used in a generic and descriptive sense only and not for purposes of limitation, the scope of the invention being set forth in the following claims.

What is claimed is:

1. A method of transmitting a message, the method comprising:
generating a random number according to a predetermined random number generation algorithm;
constructing a first security field including the random number;
encrypting the first security field to create a first digital signature;
appending the first digital signature to the message to create a packet; and
transmitting the packet including the first digital signature and the message.

2. The method of claim 1, wherein constructing a first security field is preceded by computing a Cyclic Redundancy Check (CRC) for the message, and wherein constructing the first security field comprises constructing the first security field including the first random number and the CRC.

3. The method of claim 2, wherein computing the CRC for the packet is followed by appending the CRC to the message so that the packet includes the message, the CRC, and the first security field.

4. The method of claim 1, wherein the predetermined random number generation algorithm is advanced at the first station with the transmission of each packet.

5. A method of receiving a packet including a message and a first digital signature wherein the first digital signature is generated by constructing a first security field including a first random number generated according to a predetermined random number generation algorithm and encrypting the first security field, the method comprising:
receiving the packet including the first digital signature and the message;
generating a second random number according to the predetermined random number generation algorithm;
constructing a second security field including the second random number; and
comparing the second security field including the second random number and the first digital signature.

6. The method of claim 5, wherein comparing the second security field comprises:
encrypting the second security field to create a second digital signature; and
comparing the first digital signature and the second digital signature.

7. The method of claim 5, wherein comparing the second security field comprises:
unencrypting the first digital signature to obtain the first security field; and
comparing the first security field and the second security field.

8. The method of claim 5, wherein the first security field includes the first random number and a first cyclic redundancy check for the message, and wherein constructing a second security field is preceded by:
computing a second Cyclic Redundancy Check for the message portion of the packet;
wherein constructing the second security field comprises constructing the second security field including the second random number and the second CRC.

9. The method of claim 8, further comprising:
verifying validity of the message portion of the packet; and
rejecting the packet if the message is not valid.

10. The method of claim 6, wherein comparing the first digital signature and the second digital signature is followed by:
determining if the first digital signature and the second digital signature are the same; and
rejecting the packet if the first digital signature and the second digital signature are not the same.

11. The method of claim 5, wherein generating the first random number according to the predetermined random number generation algorithm and generating the second random number according to the predetermined random number generation algorithm are synchronized so that the first and second random numbers are the same.

12. The method of claim 11, wherein the predetermined random number generation algorithm operates at both a first and a second station using a common seed to produce the same random number.

13. The method of claim 5, wherein the predetermined random number generation algorithm is advanced at both a first and a second station with the transmission and reception of each packet.

14. A method of authenticating a message, the method comprising:
generating at a first station a first random number according to a predetermined random number generation algorithm;
constructing at the first station a first security field including the first random number;
encrypting the first security field to create a first digital signature;
appending the first digital signature to the message to create a packet;
transmitting the packet including the first digital signature and the message to a second station;
receiving the packet including the first digital signature and the message at the second station;
generating at the second station a second random number according to the predetermined random number generation algorithm;
constructing at the second station a second security field including the second random number; and
comparing the second security field including the second random number and the first digital signature.

15. The method of claim 14, wherein comparing the second security field comprises:
encrypting the second security field to create a second digital signature; and
comparing the first digital signature and the second digital signature.

16. The method of claim 14, wherein comparing the second security field comprises:
unencrypting the first digital signature to obtain the first security field; and
comparing the first security field and the second security field.

17. The method of claim 14, wherein constructing at a first station a first security field is preceded by:
computing a Cyclic Redundancy Check (CRC) for the message;
wherein constructing the first security field comprises constructing the first security field including the first random number and the CRC.

18. The method of claim 17, wherein computing the CRC for the packet is followed by:
appending the CRC to the message so that the packet includes the message, the CRC, and the first security field.

19. The method of claim 14, wherein constructing at the second station a second security field is preceded by:
computing a second Cyclic Redundancy Check (CRC) for the message portion of the packet;
wherein generating at the second station the second security field comprises generating at the second station the second security field including the second random number and the second CRC.

20. The method of claim 14, further comprising:
verifying validity of the message portion of the packet; and
rejecting the packet if the message is not valid.

21. The method of claim 15, wherein comparing the first digital signature and the second digital signature is followed by:
determining if the first digital signature and the second digital signature are the same; and
rejecting the packet if the first digital signature and the second digital signature are not the same.

22. The method of claim 14, wherein generating at the first station the first random number according to the predetermined random number generation algorithm and generating at the second station the second random number according to the predetermined random number generation algorithm are synchronized so that the first and second random numbers are the same.

23. The method of claim 22, wherein the predetermined random number generation algorithm operates at both the first and second stations using a common seed to produce the same random number.

24. The method of claim 14, wherein the predetermined random number generation algorithm is advanced at both the first and second stations with the transmission and reception of each packet.

25. A system for transmitting a message comprising:
a random number generator that generates a random number according to a predetermined random number generation algorithm;
a circuit that constructs a first security field including the random number, encrypts the first security field to create a digital signature, and appends the first digital signature to the message to create a packet; and
a transmitter that transmits the packet including the digital signature and the message.

26. The system according to claim 25, wherein the circuit that constructs a first security field is configured to compute a Cyclic Redundancy Check (CRC) for the message, wherein the first security field includes the first random number and the CRC.

27. The system according to claim 26, wherein the circuit that constructs the first security field is further configured to append the CRC to the message so that the packet includes the message, the CRC, and the first security field.

28. The system according to claim 25, wherein the random number generator is configured to advance at the first station when the transmitter transmits each packet.

29. A system for receiving a packet including a message and a first digital signature wherein the first digital signature is generated by constructing a first security field including a first random number generated according to a predetermined random number generation algorithm and encrypting the first security field, the system comprising:
a receiver that receives the packet including the first digital signature and the message;
a second random number generator that generates a second random number according to the predetermined random number generation algorithm;
a second circuit that constructs a second security field including the second random number and compares the second security field including the second random number and the first digital signature.

30. The system according to claim 29, wherein the second circuit encrypts the second security field to create a second digital signature, and compares the first digital signature and the second digital signature.

31. The system according to claim 29, wherein the second circuit unencrypts the first digital signature to obtain the first security field, and compares the first security field and the second security field.

32. The system according to claim 29, wherein the second circuit that constructs the second security field is configured to compute a second Cyclic Redundancy Check for the message portion of the packet, wherein the second security field includes the second random number and the second CRC.

33. The system according to claim 32, wherein the second circuit that generates the second security field is further configured to verify validity of the message portion of the packet and reject the packet if the message is invalid.

34. The system according to claim 29, wherein the second circuit that compares the first digital signature and the second digital signature is further configured to determine if the first digital signature and the second digital signature are the same and reject the packet if the first digital signature and the second digital signature are not the same.

35. The system according to claim 29, wherein the first random number generator that generates the first random number according to the predetermined random number generation algorithm and the second random number generator that generates the second random number according to the predetermined random number generation algorithm are synchronized so that the first and second random numbers are the same.

36. The system according to claim 35, wherein the first and second random number generators operate using a common seed to produce the same random number.

37. The system according to claim 36, wherein first and second random number generators are advanced with the transmission and reception of the packet.

38. A computer program product for transmitting a message, comprising:
a computer readable program medium having computer readable code embodied therein, the computer readable code comprising:
computer readable program code that generates a random number according to a predetermined random number generation algorithm;
computer readable program code that constructs a first security field including the random number, encrypts the first security field to create a digital signature, and appends the first digital signature to the message to create a packet; and
computer readable program code that transmits the packet including the digital signature and the message.

39. The computer program product of claim 38, wherein the computer readable program code that constructs the first security field is configured to compute a Cyclic Redundancy Check (CRC) for the message, wherein the first security field includes the first random number and the CRC.

40. The computer program product of claim 39, wherein the computer readable program code that constructs the first security field is further configured to append the CRC to the message so that the packet includes the message, the CRC, and the first security field.

41. The computer program product of claim 38, wherein the predetermined random number generation algorithm is configured to advance at the first station when the transmitter transmits each packet.

42. A computer program product for receiving a packet including a message and a first digital signature wherein the first digital signature is generated by computer readable program code that constructs a first security field including a first random number according to a predetermined random number generation algorithm and encrypts the first security field, comprising:
a computer readable program medium having computer readable code embodied therein, the computer readable code comprising:
computer readable program code that receives the packet including the first digital signature and the message;
computer readable program code that generates a second random number according to the predetermined random number generation algorithm;
computer readable program code that constructs a second security field including the second random number and compares the second security field including the second random number to the first digital signature.

43. The computer program product of claim 42, wherein the computer readable program code that compares the second security field is configured to encrypt the second security field to create a second digital signature and compare the first digital signature and the second digital signature.

44. The computer program product of claim 42, wherein the computer readable program code that compares the second security field is configured to unencrypt the first digital signature to obtain the first security field and compare the first security field and the second security field.

45. The computer program product of claim 42, wherein the computer readable program code that constructs the second security field is configured to compute a second Cyclic Redundancy Check for the message portion of the packet, wherein the second security field includes the second random number and the second CRC.

46. The computer program product of claim 45, wherein the computer readable program code that constructs the second security field is further configured to verify validity of the message portion of the packet and reject the packet if the message is not valid.

47. The computer program product of claim 42, wherein the computer readable program code that compares the first digital signature and the second digital signature is further configured to determine if the first digital signature and the second digital signature are the same and reject the packet if the first digital signature and the second digital signature are not the same.

48. The computer program product of claim 47, wherein the computer readable program code that generates the first random number according to the predetermined random number generation algorithm and the computer readable program code that generates the second random number according to the predetermined random number generation algorithm are configured so that the first and second random numbers are the same.

49. The computer program product of claim 48, wherein the predetermined random number generation algorithm is configured to operate at both the first and second stations using a common seed to produce the same random number.

50. The computer program product of claim 42, wherein the predetermined random number generation algorithm is configured to advance with the transmission and reception of each packet.
